(19) United States
(12) Patent Application Publication
(10) Pub. No.: US 2009/0019513 A1
(43) Pub. Date: Jan. 15, 2009

(54) METHOD AND APPARATUS FOR CHANGING CHANNEL IN DIGITAL BROADCASTING RECEIVER

(75) Inventors: Yeong-kyeong SEONG, Suwon-si (KR); Yoon-hee CHOI, Suwon-si (KR); Hyo-jung SONG, Seoul (KR); Min-kyu PARK, Seoul (KR); In-cheol PARK, Incheon (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/037,383

(22) Filed: Feb. 26, 2008

(30) Foreign Application Priority Data
Jul. 9, 2007 (KR) 10-2007-0068801

(51) Int. Cl. H04N 7/16

(52) U.S. Cl. 725/151

(57) ABSTRACT

A method and apparatus for changing a channel in a digital broadcasting receiver and for hiding a delay that occurs due to the change of the channel are provided. The method includes receiving broadcasting data of at least one channel except for a current channel by using a time division method, based on a pre-set schedule; storing the received broadcasting data; and when a control signal for changing a channel is input, outputting broadcasting contents of the changed channel, which corresponds to the control signal, to the display device by using the stored broadcasting data.

### CROSS-REFERENCE TO RELATED PATENT APPLICATION

This application claims priority from Korean Patent Application No. 10-2007-0068801, filed on Jul. 9, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to changing of a channel in a digital broadcasting receiver, and more particularly, to changing a channel in the digital broadcasting receiver and for hiding a delay that occurs due to the change of the channel.

2. Description of the Related Art

Since display technologies have become well developed, demand for higher video quality has increased in regard to selecting of a broadcasting receiver. Accordingly, digital broadcasting receivers which can receive digital broadcasts are preferable compared to existing analog broadcasting receivers.

However, unlike analog broadcasting receiving, a considerable delay occurs while changing a channel in digital broadcasting receiving. In the case of digital broadcasting, when a command for changing a channel is input, a video buffer should be initialized and conditions for decoding should be satisfied so as to perform video decoding for changing a channel.

FIG. 1 is a block diagram of a related art digital broadcasting receiver 100 which outputs broadcasting contents.

The digital broadcasting receiver 100 includes a tuner 110, a demodulator 120, a demultiplexer 130, and a decoder 140.

The tuner 110 selects a desired frequency band from a broadcasting signal.

The demodulator 120 demodulates the signal that passes through the tuner 110 and extracts a Transport Stream (TS). That is, a channel coded signal is extracted and is converted into a digital signal.

The demultiplexer 130 separates audio, video, program information and data, respectively, included in the TS received from the demodulator 120. Here, the program information is Program and System Information (PSI), and is information for extracting required data from among an input TS in which a variety of audio and video are multiplexed into one stream. The demultiplexer 130 extracts PSI and obtains information on a channel such as an audio program ID (PID) and a video PID. The demultiplexer 130 extracts audio data and video data required to output contents of a current channel from among TS data input to the demultiplexer 130 by using an obtained PID.

The decoder 140 decodes extracted audio data and video data. The decoder 140 includes a video decoder 142 and an audio decoder 144. The video decoder 142 decodes video data and the audio decoder 144 decodes audio data. When an Intra-Picture (I-Picture) is delivered from the demultiplexer 130, the decoder 140 starts decoding the delivered data. An I-Picture is a picture which can be decoded by itself without depending upon other pictures. Thus, the decoder 140 starts decoding at the point of time when the I-Picture is firstly input.

According to the related art digital broadcasting receiver, tuner stabilizing, PSI information extracting, and I-frame input are needed until a channel is changed. Accordingly, when a user handles a remote-control for changing a channel, the user should wait for approximately 1 or 2 seconds for the channel to be changed. Therefore, users, who are familiar with analog broadcasting receivers in which the handling of the remote control and changing of the channel are simultaneously accomplished, experience inconvenience.

### SUMMARY OF THE INVENTION

The present invention provides a method and apparatus for changing a channel by using an extra tuner and buffer which display time delayed video while changing the channel so as to remove a delay that occurs while changing the channel in a digital broadcasting receiver.

According to an aspect of the present invention, there is provided a method of changing a channel in a digital broadcasting receiver, the method including: receiving broadcasting data of at least one channel except for a current channel by using a time division method, based on a pre-set schedule; storing the received broadcasting data; and when a control signal for changing a channel is input, outputting broadcasting contents of the changed channel, which corresponds to the control signal, to a display device by using the stored broadcasting data.

The method may further include determining whether a predetermined process required to output broadcasting contents of the changed channel to the display device in real-time is completed, wherein when the predetermined process is completed, broadcasting contents of the changed channel is output to the display device in real-time.

The predetermined process required to output broadcasting contents of the changed channel to the display device in real-time may include at least one of tuning to the changed channel, Program and System Information (PSI) information extracting, and I frame input standby.

At least one channel may be adjacent to the current channel.

At least one channel may be a channel preferred by a user.

In the outputting the broadcasting contents, a frame may be added based on the stored broadcasting data and broadcasting contents of the changed channel is output to a display device based on the added broadcasting data.

The stored broadcasting data may be audio-video (A/V) data.

According to another aspect of the present invention, there is provided an apparatus for changing a channel in a digital broadcasting receiver, the apparatus including: a receiving unit which receives broadcasting data of at least one channel except for a current channel by using a time division method, based on a pre-set schedule; a storing unit which stores the received broadcasting data; and an outputting unit which outputs broadcasting contents of the changed channel, which corresponds to the control signal, to a display device by using the stored broadcasting data, when a control signal for changing a channel is input.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a related art digital broadcasting receiver which outputs broadcasting contents;

FIG. 2 is a flowchart of a method of changing a channel in a digital broadcasting receiver according to an exemplary embodiment of the present invention;

FIG. 3 illustrates an example of executing the method of changing a channel according to an exemplary embodiment of the present invention;

FIG. 4 illustrates an example of outputting stored data to a display device according to an exemplary embodiment of the present invention;

FIG. 5 is a block diagram of an apparatus for changing a channel according to an exemplary embodiment of the present invention; and

FIG. 6 is a detailed block diagram of the apparatus for changing a channel, illustrated in FIG. 5, according to an exemplary embodiment of the present invention.

### DETAILED DESCRIPTION OF EXEMPLARY EMBODIMENTS

Hereinafter, the present invention will be described more fully with reference to the accompanying drawings, in which exemplary embodiments of the invention are shown.

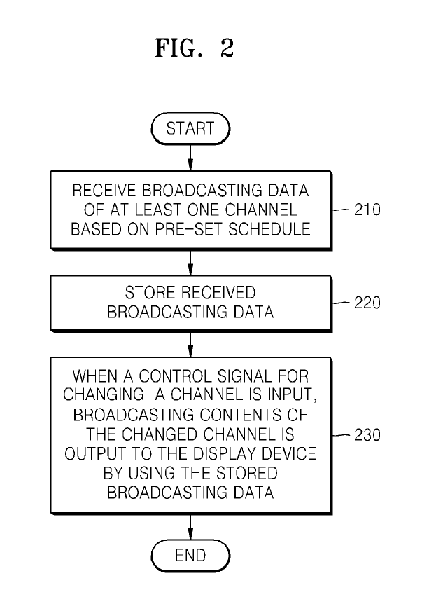

FIG. 2 is a flowchart of a method of changing a channel in a digital broadcasting receiver according to an exemplary embodiment of the present invention.

In operation 210, broadcasting data of at least one channel except for a current channel is received by using a time division method, based on a pre-set schedule. The current channel is referred to as a currently displaying channel in a display device.

For example, when the current channel is channel 1, broadcasting data of channel 2, channel 3, and channel 4 are received by using a time division method based on pre-set conditions. During an initial time T1, broadcasting data of channel 2 is received. Then, broadcasting data of channel 3 is received during a next time T2. Then, broadcasting data of channel 4 is received during a next time T3. Next, broadcasting data of channel 2 is received again during next T1. Accordingly, while the current channel 1 is displayed, broadcasting data of a predetermined channel is received by using a time division method.

In this case, the channels except for the current channel can be set (a) all channels which can be received by the digital broadcasting receiver, (b) the channels adjacent to the current channel, or (c) the channels preferred by a user.

In addition, a time (for example, T1, T2, and T3) for receiving broadcasting data of the channels except for the current channel can vary according to the pre-set conditions, and broadcasting data of two or more channels can be received at a time by using two or more extra tuners.

In operation 220, broadcasting data received in operation 210 is stored.

The received broadcasting data may be A/V data. A form of the stored broadcasting data is not particularly restricted. That is, data in which decoding is completed can be stored, or data in which decoding is not yet completed can be stored.

In operation 230, when a control signal for changing a channel is input, broadcasting contents of the changed channel, which corresponds to the control signal, is output to the display device by using the stored broadcasting data.

For example, while current channel 1 is being displayed, a control signal for changing a channel to channel 2 is input, broadcasting contents of channel 2 are output to the display device by using broadcasting data of channel 2 from among the stored data.

When decoding of the stored data is completed, the stored data can be output to the display device without any additional process. However, when decoding of the stored data is not completed, the stored data can be output to the display device after decoding is completed.

In addition, in outputting broadcasting contents of the changed channel by using the stored broadcasting data, a frame can be added based on the stored broadcasting data, and broadcasting contents of the changed channel can be output based on the broadcasting data to which the frame is added.

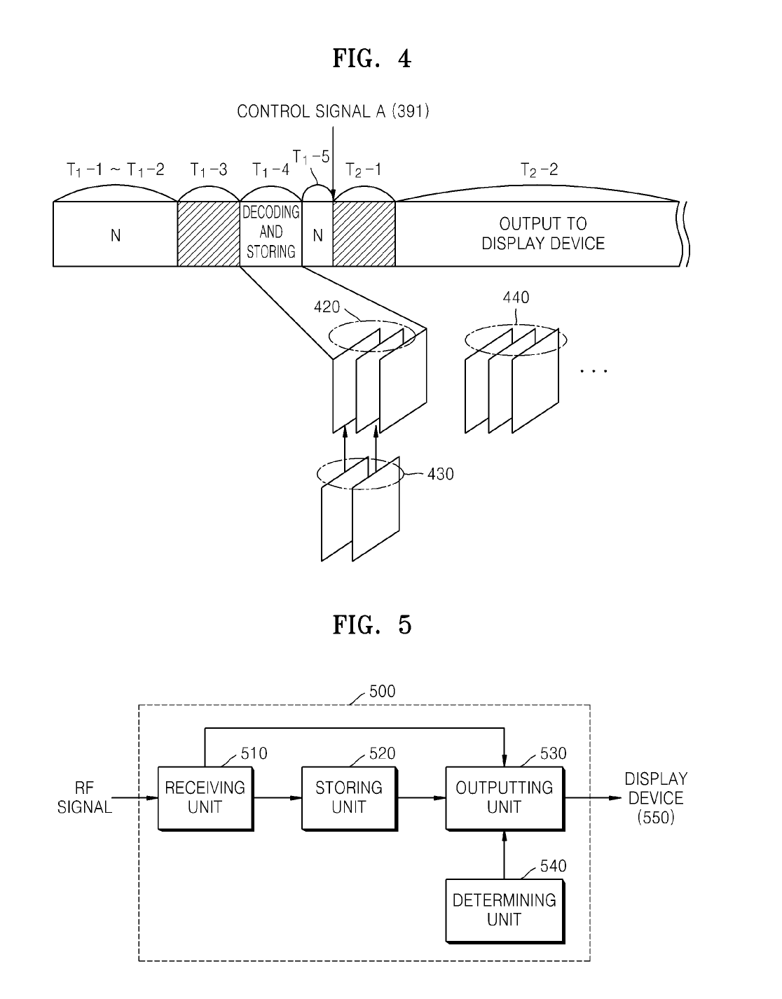

A method of outputting broadcasting contents of the changed channel will be described more fully with reference to FIG. 4.

The method of changing a channel according to an exemplary embodiment of the present invention may further include the following process.

It is determined whether a predetermined process required to output broadcasting contents of the changed channel to the display device in real-time is completed. The predetermined process required to output broadcasting contents of the changed channel to the display device in real-time is referred to as a process required to decode broadcasting contents of the changed channel. As mentioned above, the predetermined process may be at least one among tuning to the changed channel, PSI information extracting, and I frame input standby.

When the predetermined process is completed, broadcasting contents of the changed channel is output to the display device in real-time.

The broadcasting contents of the change channel is output by using data stored in operation 230 in order for a user not to recognize a delay that occurs while changing a channel. Accordingly, when the predetermined process required to display the changed channel in real-time is completed, an operation of outputting broadcasting contents of the changed channel by using the stored data is stopped. Then, broadcasting contents of the changed channel is displayed in real-time.

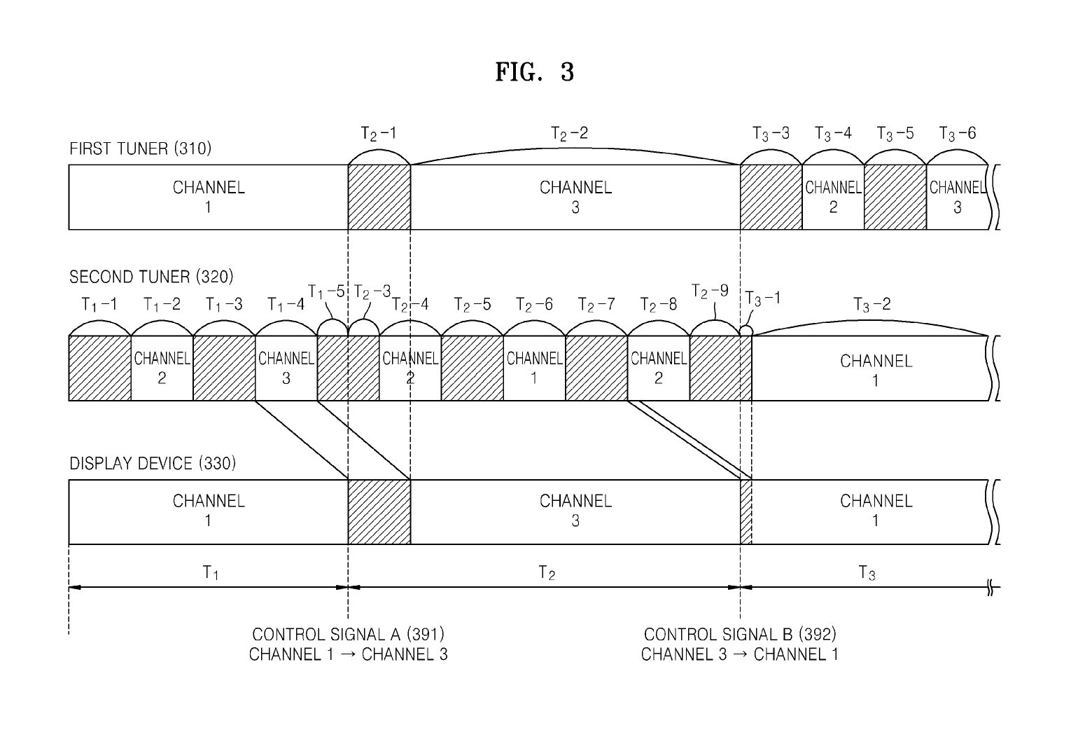

FIG. 3 illustrates an example of changing a channel according to an exemplary embodiment of the present invention.

In the current exemplary embodiment of the present invention, a first tuner 310 and a second tuner 320 are used to change a channel. However, the number of the tuners is not limited thereto.

The first tuner 310 tunes channel 1 during T1. That is, the current channel during T1 is channel 1 and broadcasting contents of the channel 1 is output to a display device 330 through the first tuner 310.

The second tuner 320 tunes at least one channel except for channel 1 during T1 based on a pre-set schedule. In the current exemplary embodiment of the present invention, the second tuner 320 tunes channel 2 and channel 3.

T1-1 is a preparation period for decoding broadcasting data of channel 2 by the second tuner 320. During T1-1, tuning to channel 2, demodulating, multiplexing, PSI information extracting, and I frame input standby are performed.

During T1-2, the second tuner 320 tunes channel 2 and stores broadcasting data of the tuned channel 2 in a buffer.

The length of T1-1 which is a preparation period and the length of T1-2 which is a period for storing broadcasting data may vary according to the pre-set schedule. In the current exemplary embodiment of the present invention, the lengths of T1-1 and T1-2 are same. Accordingly, stored data is reproduced during T1-1 which is a preparation period for changing a channel so that a user cannot recognize a delay.

T1-3 is a preparation period for decoding broadcasting data of channel 3 by the second tuner 320. During T1-3, tuning to channel 3, demodulating, multiplexing, PSI information extracting, and I frame input standby are performed.

During T1-4, the second tuner 320 tunes channel 3 and stores broadcasting data of tuned channel 3 to the buffer.

In the current exemplary embodiment of the present invention, while the first tuner 310 outputs broadcasting contents of the current channel to the display device 330, the second tuner 320 alternately tunes broadcasting contents of two channels such as channel 2 and channel 3 except for the current channel, and stores the tuned broadcasting contents. However, the present invention is not limited thereto and kinds of preliminary channels, the number of the preliminary channels, and amounts of broadcasting contents of a preliminary channel to be stored are determined according to the pre-set schedule.

T1-5 is a preparation period for decoding broadcasting data of channel 2 by the second tuner 320. During T1-5, a control signal A 391 for changing a channel from channel 1 to channel 3 is transmitted.

T2-1 is a preparation period for changing the current channel from channel 1 to channel 3 corresponding to the control signal A 391 by using the first tuner 310. During T2-1, broadcasting contents stored by the second tuner 320 are output to the display device 330 so that a user cannot recognize a delay that occurs during changing of a channel. In the current exemplary embodiment of the present invention, broadcasting contents of channel 3 stored during T1-4 are reproduced.

When the preparation for outputting channel 3 is ready, output of the stored broadcasting contents is completed. Simultaneously, broadcasting contents of channel 3 are output to the display device 330 in real-time by the first tuner 310.

During T2-2, the first tuner 310 tunes channel 3 and broadcasting contents of the tuned channel is output to the display device 330. That is, the current channel during T2-2 is channel 3 and broadcasting contents of channel 3 is output to the display device 330 through the first tuner 310.

During T2-3 through T2-9, the second tuner 320 alternately tunes channel 2 and channel 1 according to the pre-set schedule and broadcasting contents of the tuned channels are stored in the buffer.

T2-9 is a preparation period for decoding broadcasting data of channel 1 by the second tuner 320. During T2-9, a control signal B 392 for changing a channel from channel 3 to channel 1 is input.

T3-1 is a remaining period for decoding broadcasting contents of channel 1 in the buffer by the second tuner 320. During T3-1, broadcasting contents stored by the second tuner 320 are output to the display device 330 so that a user cannot recognize the delay that occurs during changing of a channel. In the current exemplary embodiment of the present invention, broadcasting contents of channel 1 stored during T2-6 are output.

When the preparation for outputting the changed channel is ready, output by using the stored broadcasting contents is stopped. In the current exemplary embodiment of the present invention, since the second tuner 320 prepares for outputting channel 1 at the point of time when the control signal B 392 is transmitted, preparation is completed quickly. Simultaneously, the preparation is completed and broadcasting contents of channel 1 are output to the display device 330 in real-time by the second tuner 320.

During T3-2, the second tuner 320 tunes channel 1 and broadcasting contents of the tuned channel are output to the display device 330. That is, the current channel during T3-2 is channel 1 and broadcasting contents of channel 1 are output to the display device through the second tuner 320.

During T3-3 through T3-6, the first tuner 310 alternately tunes channel 2 and channel 3 according to the pre-set schedule and broadcasting contents of the tuned channels are stored in the buffer.

FIG. 4 illustrates an example of outputting stored data to the display device according to an exemplary embodiment of the present invention.

In FIG. 4, channel 3 is tuned as described with reference to FIG. 3.

Referring to FIG. 3, during T1-1 through T1-2, the first tuner 310 tunes channel 1 and the second tuner 320 tunes channel 2. Therefore channel 3 is not tuned, and T1-1 through T1-2 is illustrated as N in the current exemplary embodiment of the present invention.

T1-3 is a preparation period for decoding broadcasting data of channel 3 by the second tuner 320. During T1-3, tuning to channel 3, demodulating, multiplexing, PSI information extracting, and I frame input standby are performed.

During T1-4, the second tuner 320 tunes channel 3 and stores broadcasting data of the tuned channel 3 in the buffer.

During T1-5, the first tuner 310 tunes channel 1, and the second tuner 320 prepares for decoding broadcasting data of channel 2. Therefore, T1-5 is illustrated as N which indicates that channel 3 is not tuned.

During T1-5, the control signal A 391 for changing a channel from channel 1 to channel 3 is input.

T2-1 is a preparation period for changing the current channel from channel 1 to channel 3 corresponding to the control signal A 391 performed by the first tuner 310. During T2-1, broadcasting data 420 stored by the second tuner 320 is output to the display device so that a user cannot recognize the delay that occurs during changing of a channel. In the current exemplary embodiment of the present invention, broadcasting data 420 of channel 3 stored during T1-4 is output to the display device.

When the preparation for changing a channel is ready, the first tuner 310 tunes channel 3 and broadcasting contents 440 of the tuned channel 3 is output to the display device in real-time. Therefore, broadcasting contents 440 of channel 3 will be displayed in real-time from the point of time when the preparation for changing a channel is completed.

In the current exemplary embodiment of the present invention, broadcasting data of a preliminary channel is stored so as to be reproduced during the time taken for the preparation for changing a channel. Therefore, the time taken for the preparation and the time for outputting stored broadcasting data are the same.

However, in some cases, broadcasting data of various channels should be stored by using a small number of extra tuners. In this case, the time for outputting broadcasting data of the stored preliminary channel may be shorter than the time taken for the preparation.

In order to address this matter, a frame is added based on the stored broadcasting data and broadcasting contents of the changed channel is output to the display device based on the broadcasting data to which the frame is added.

For example, when the stored broadcasting data 420 is not sufficient for reproduction during the time for preparing changing a channel, additional frames 430 are inserted based on the stored broadcasting data 420. The additional frames 430 are generated with reference to insertion locations within the broadcasting data 420, and any method can be used to generate the additional frames 430.

The additional frames 430 are inserted into the stored broadcasting data 420 and are output to the display device. Accordingly, the time taken for preparing for outputting of the changed channel and the time for outputting stored broadcasting data are the same. Therefore, the user cannot recognize the delay during changing of a channel.

FIG. 5 is a block diagram of an apparatus for changing a channel according to an exemplary embodiment of the present invention.

The apparatus for changing a channel 500 includes a receiving unit 510, a storing unit 520, and an outputting unit 530.

The receiving unit 510 receives broadcasting data of at least one channel except for a current channel by using a time division method.

The storing unit 520 stores broadcasting data received by the receiving unit 510.

A processing unit (not illustrated) is connected to a front end or a back end of the storing unit 520 or embodied with the outputting unit 530. When broadcasting data stored in the storing unit 520 can be directly output to the displaying unit, the processing unit (not illustrated) is not required. However, when broadcasting data stored in the storing unit 520 cannot be directly output to the display device, the form of broadcasting data is changed so as to be outputted to the display device by the processing unit (not illustrated).

When a control signal for changing a channel is input to the outputting unit 530, the outputting unit 530 outputs broadcasting contents of the change channel, which corresponds to the control signal, to a display device 550 by using broadcasting data stored in the storing unit 520.

The apparatus for changing a channel 500 may further include a determining unit 540.

The determining unit 540 determines whether a predetermined process required to output broadcasting contents of the changed channel to the display device in real-time is completed.

When it is determined that the predetermined process required to output broadcasting contents of the changed channel to the display device in real-time is completed, the outputting unit 530 outputs broadcasting data so that broadcasting contents of the changed channel is output to the display device 550 in real-time.

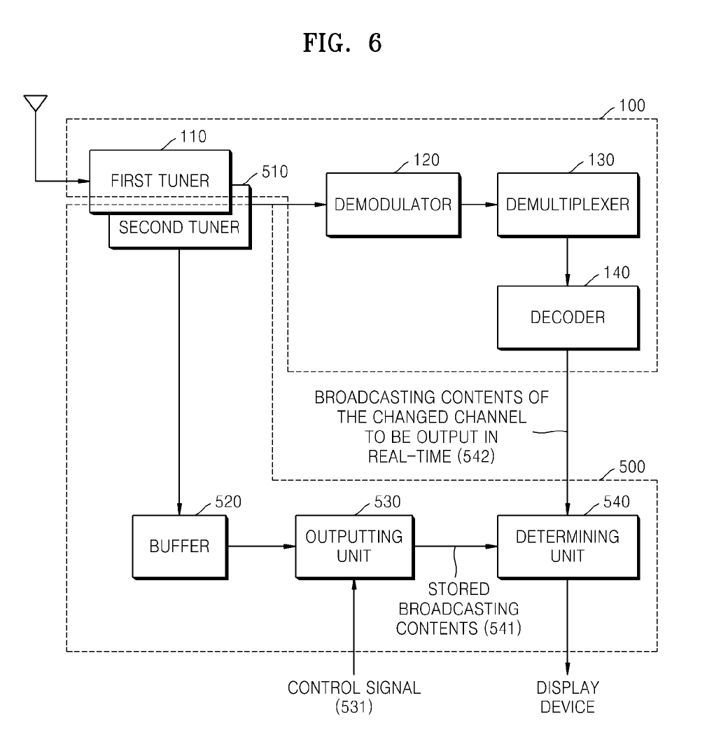

FIG. 6 is a detailed block diagram of the apparatus for changing a channel 500, illustrated in FIG. 5.

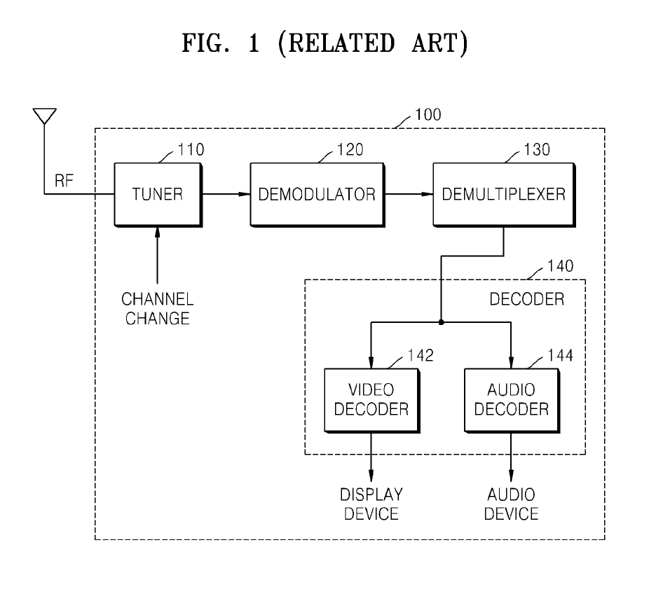

The related art digital broadcasting receiver 100 includes the tuner 110, the demodulator 120, the demultiplexer 130, and the decoder 140. The related art digital broadcasting receiver 100 is described with reference to FIG. 1 and thus a detailed description thereof will be omitted here.

The apparatus for changing a channel 500 includes a second tuner 510, a buffer 520, the outputting unit 530, and the determining unit 540.

The second tuner 510 extracts a specific frequency signal as a radio frequency (RF) signal and thus receives broadcasting data of a desired channel. The second tuner 510 receives broadcasting data of at least one channel except for a current channel based on a pre-set schedule by using a time division method.

The buffer 520 stores broadcasting data received from the second tuner 510.

When a control signal 531 for changing a channel is input to the outputting unit 530, the outputting unit 530 outputs broadcasting contents 541 of the change channel, which corresponds to the control signal 531, to the display device by using broadcasting data stored in the buffer 520.

When broadcasting data stored in the buffer 520 cannot be directly output to the display device, the outputting unit 530 may further include a processing unit (not illustrated). According to the form of broadcasting data stored in the buffer 520, the processing unit (not illustrated) may not be needed or may be connected to a front end of the outputting unit 530.

The processing unit (not illustrated) may include at least one of a demodulator, a demultiplexer, and a decoder according to the form of the stored broadcasting data. The detailed description of the demodulator, the demultiplexer, and the decoder is the same as described with reference to FIG. 1 and thus will be omitted here.

The determining unit 540 determines whether a predetermined process required to output broadcasting contents of the changed channel to the display device in real-time is completed.

When it is determined that the predetermined process required to output broadcasting contents of the changed channel to the display device in real-time is completed, broadcasting contents 542 of the changed channel are output to the display device in real-time.

When it is determined that the predetermined process required to output broadcasting contents of the changed channel to the display device in real-time is not completed, stored broadcasting contents 541 is output to the display device.

According to the present invention, a quick response is made in response to a user's request to change a channel so that the user cannot recognize the delay that occurs due to a preparation for changing a channel.

The exemplary embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media.

While the present invention has been particularly shown and described with reference to the exemplary embodiments thereof, it will be understood by those of ordinary skill in the art that various changes in form and details may be made therein without departing from the spirit and scope of the present invention as defined by the following claims.

What is claimed is:

1. A method of changing a channel in a digital broadcasting receiver, the method comprising:
receiving broadcasting data of at least one channel except for a current channel by using a time division method, based on a pre-set schedule;
storing the received broadcasting data; and
if a control signal for changing to a new channel is input, outputting broadcasting contents of the new channel, which corresponds to the control signal, by using the stored broadcasting data.

2. The method of claim 1, further comprising determining whether a process to output the broadcasting contents of the new channel in real-time is completed, wherein if it is determined that the process is completed, the broadcasting contents of the new channel are output in real-time.

3. The method of claim 2, wherein the process to output the broadcasting contents of the new channel in real-time comprises at least one of tuning to the new channel, extracting Program and System Information (PSI) information, and I frame input standby.

4. The method of claim 1, wherein the at least one channel is adjacent to the current channel.

5. The method of claim 1, wherein the at least one channel is a channel preferred by a user.

6. The method of claim 1, wherein in the outputting the broadcasting contents, a frame is added to the stored broadcasting data, and the broadcasting contents of the new channel is output based on the broadcasting data to which the frame is added.

7. The method of claim 1, wherein the stored broadcasting data is audio-video (A/V) data.

8. An apparatus for changing a channel in a digital broadcasting receiver, the apparatus comprising:
a receiving unit which receives broadcasting data of at least one channel except for a current channel by using a time division method, based on a pre-set schedule;
a storing unit which stores the received broadcasting data; and
an outputting unit which outputs broadcasting contents of a new channel, which corresponds to a control signal for changing to the new channel, by using the stored broadcasting data, if the control signal is input.

9. The apparatus of claim 8, further comprising a determining unit which determines whether a process to output the broadcasting contents of the new channel in real-time is completed, wherein if the process is completed, the outputting unit outputs the broadcasting contents of the new channel in real-time.

10. The apparatus of claim 9, wherein the process required to output broadcasting contents of the new channel in real-time comprises at least one of tuning to the new channel, extracting Program and System Information (PSI) information, and I frame input standby.

11. The apparatus of claim 8, wherein the at least one channel is adjacent to the current channel.

12. The apparatus of claim 8, wherein the at least one channel is a channel preferred by a user.

13. The apparatus of claim 8, wherein the outputting unit adds a frame based on the stored broadcasting data and outputs the broadcasting contents of the new channel based on the broadcasting data to which the frame is added.

14. The apparatus of claim 8, wherein the stored broadcasting data is audio-video (A/V) data.

15. A computer readable recording medium having embodied thereon a computer program for executing a method comprising:
receiving broadcasting data of at least one channel except for a current channel by using a time division method, based on a pre-set schedule;
storing the received broadcasting data; and
if a control signal for changing to a new channel is input, outputting broadcasting contents of the new channel, which corresponds to the control signal, by using the stored broadcasting data.
